(19) United States
(12) Patent Application Publication
(10) Pub. No.: US 2002/0157520 A1
(43) Pub. Date: Oct. 31, 2002

(54) Wind instrument

(76) Inventor: Rienk Smeding, De Wijk (NL)

Correspondence Address: Mark Zovko, 36504 28th Avenue South, Federal Way, WA, 98003, US

(21) Appl. No.: 09/914,685

(22) PCT Filed: Mar. 2, 2001
(86) PCT No.: PCT/NL00/00130

(30) Foreign Application Priority Data
Mar. 3, 1999 (BE) 9900147

(51) Int. Cl. G10D 7/08

(52) U.S. Cl. 84/385 R

(57) ABSTRACT

The invention relates to a wind instrument, for instance, a saxophone or flute. The invention is based on the discovery that a wind instrument, for instance of copper or brass, can be markedly improved by at least one chemically applied coating of hard material. Such a coating applied to the inner side of the tube improves the sound. A coating of phosphor-nickel, preferably with PTFE, applied to the outer side of the instrument has an exceptionally attractive appearance and is less susceptible to scratching. If a coating is applied in swivel bearings of the valve mechanism, disturbing mechanical sounds are reduced and the mechanism moves with less resistance.

The invention relates to a wind instrument, for instance a saxophone or flute.

The invention is based on the discovery that a wind instrument, for instance of copper or brass, can be markedly improved by at least one chemically applied coating of hard material.

Such a coating applied to the inner side of the tube improves the sound.

A coating of phosphor-nickel, preferably with PTFE, applied to the outer side of the instrument has an exceptionally attractive appearance and is less susceptible to scratching.

If a coating is applied in swivel bearings of the valve mechanism, disturbing mechanical sounds are reduced and the mechanism moves with less resistance.

The invention is elucidated in the description following hereinbelow with reference to drawings, in which:

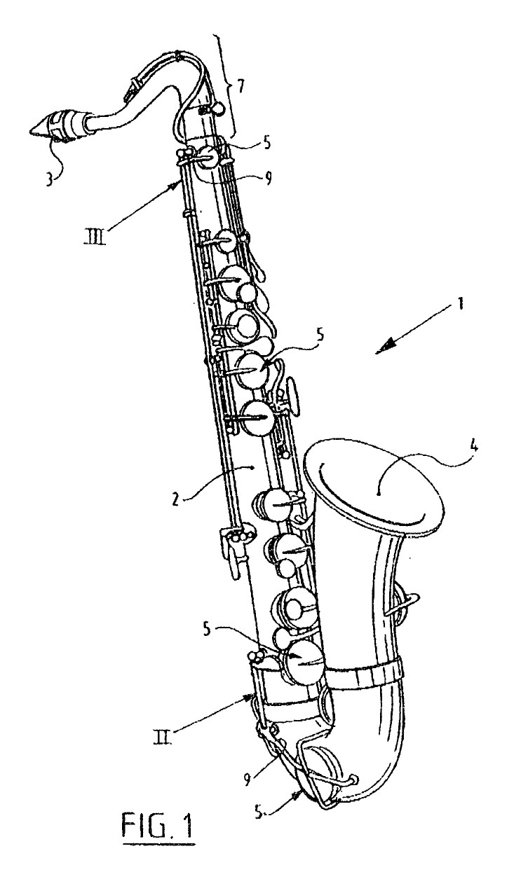

FIG. 1 shows a perspective view of a saxophone;

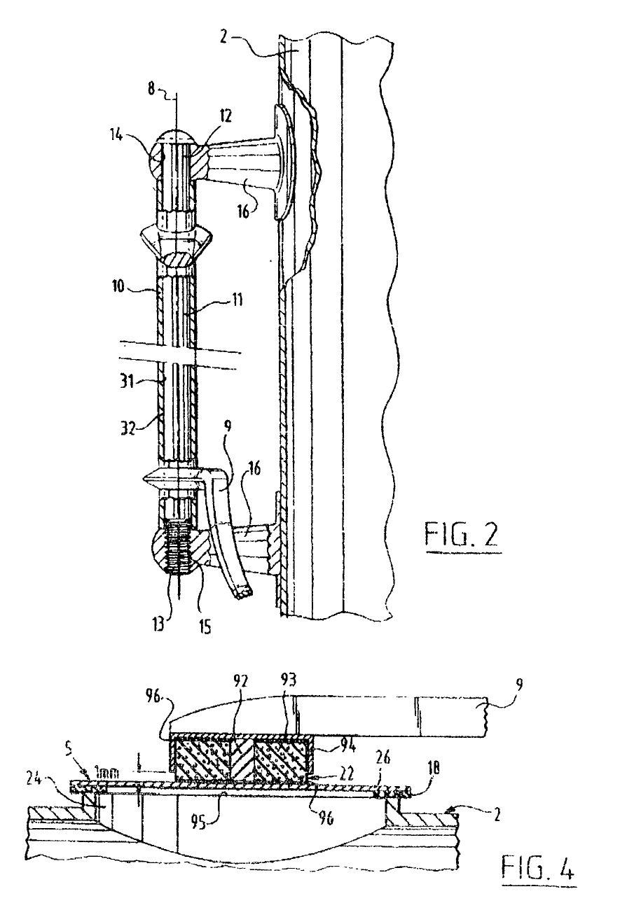

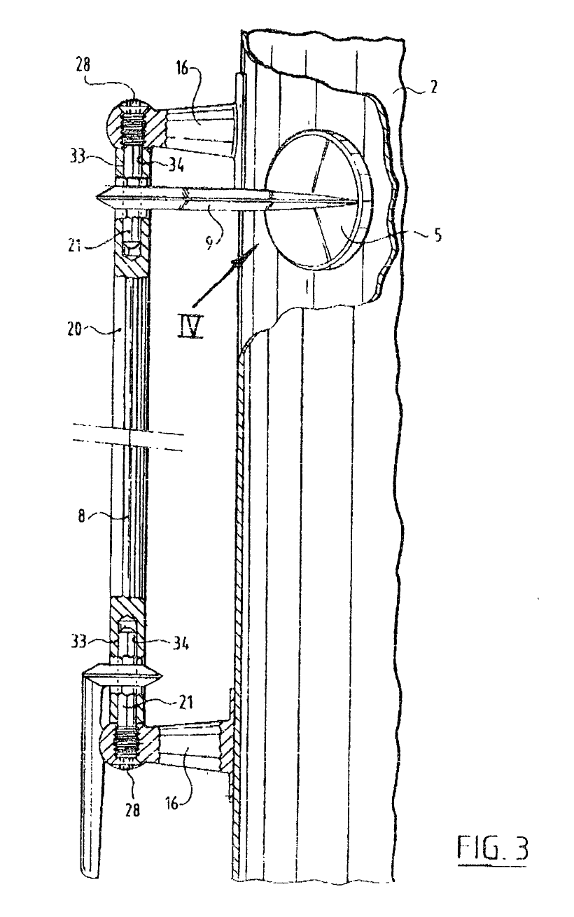

FIGS. 2 and 3 show a cross section of respectively detail II and III of FIG. 1.

FIG. 4 shows a partly broken detail according to the arrow IV in FIG. 3.

The saxophone 1 shown in FIG. 1 has a tube comprising a neck 7 having connected thereto a hull 2 of metal, for instance brass, copper, steel or an alloy with nickel, copper and/or zinc, in which extends a duct. A hull of wood, hard plastic or composite material, such as ground hard wood with epoxy resin, is also possible in the case of particular instruments, for instance flutes, transverse flutes, bassoons or saxophones.

The tube extends from a mouthpiece 3 to an end opening 4.

In the peripheral wall of the tube are arranged a number of openings which can be closed or opened by valves 5. The length of a resonance column (the tone) is determined by selecting the valve 5 for opening.

Valves 5 are pivotable on axes 8 in that as according to FIG. 2 or 3 they are mounted with their arms 9 on pivot bearing members which pivot relative to fixed bearing members.

In FIG. 2 the pivot bearing member is a tube 10 which pivots on a rod 11 which is received at its head end 12 and threaded end 13 in a fitting hole 14 respectively in threaded hole 15 of supports 16 fixed to hull 2.

In FIG. 3 the pivot bearing member is a rod 20 which pivots at each end on a pin 21 forming part of a screw 28 screwed fixedly into a support 16.

The fitting surfaces 31, 32 between tube 10 and rod 11 and the fitting surfaces 33, 34 between rod 20 and pin 21 have a difference in diameter of i 0.1-0.2 mm after normal manufacture.

According to the invention at least one, but preferably each of the co-acting surfaces 31-34 is provided with a coating of hard material, for instance nickel or phosphor-nickel. This coating makes the fitting surfaces harder and smoother. A further coating of phosphor-nickel with PTFE is preferably applied thereover, which reduces friction even further. The PTFE component provides a kind of lubrication. Lubrication with grease or oil is unnecessary. The applied coating or coatings reduce the normal play. The components with tight mutual fit and provided according to the invention with a coating provide a valve mechanism which is practically free of play but which still pivots with little resistance.

The elements 10, 11, 20 and 21 in addition to the hull 2 manufactured from copper, brass, zinc or other material, preferably metal, and optionally also the neck 7 are nickel-plated separately, preferably in a chemical bath, after internal and external degreasing and cleaning. Arranged hereover in a chemical bath (i.e. in a substantially currentless bubble bath or mixing bath) is a composite layer consisting of a nickel-phosphor matrix and finely distributed PTFE particles of a size in the order of magnitude of 1 micron. The layer thickness is in practice for instance a total of between 7 μm and 20 μm. Practical is 6 μm nickel phosphor and 10 μm phosphor-nickel with for instance 10-50%, preferably 20-30% PTFE.

These layers applied internally over more than 50% of the tube length, preferably over the whole tube length, provide an improvement in sound and these external layers provide an attractive, scratch-resistant exterior. The dispersion is kept in movement in the bath due to stirring or bubbling.

The coating on fitting surfaces internally and/or externally on the tube can less preferably consist of chemically applied NiP+SiC.

Tubes 10 preferably have fitting surfaces on the associated rod 11 only at their ends in that a thin cylindrical layer of rod 11 or the bore of tube 10 is removed between these ends.

The invention is of particular importance in an instrument of good quality, such as described in EP 96.902494.2 A, the content of which should be deemed interpolated herein, i.e. in instruments wherein a number of valves 5 each comprise a stiff, preferably thin metal plate 26 which is provided on the side directed toward opening 24 with a thin sealing layer 18 of elastic foam plastic with closed cells and which on the other side supports via a central hard elastic cushion 92, for instance of hard rubber, against a support member 94 of control means 9 and is fixed to this support member 94 by means of at least one flexible, preferably annular, fixing member 93 which is fixedly adhered to plate 95 and support member 94, for instance by means of glue layers, and which preferably consists of a membrane of a ring of soft elastic foam plastic enclosed by a cup-shaped support member 94. The preferably round support member 94 mounted on a pivot arm 9 herein has a diameter which is only a fraction of the diameter of the associated opening 24. The mass closing the opening 24 is thus small.

1. Wind instrument, comprising a tube provided with holes, characterized by at least one chemically applied coating of hard material.

2. Wind instrument as claimed in claim 1, characterized in that the tube is provided at least on its inner side with a coating of chemically applied hard material.

3. Wind instrument as claimed in claim 1 or 2, characterized in that the inner side of the tube is provided over more than 50% of its length, preferably over substantially its whole length, which at least one coating of chemically applied hard material.

4. Wind instrument as claimed in claim 1, 2 or 3, characterized in that the coating comprises nickel with SiC particles applied without current.

5. Wind instrument as claimed in claim 1, 2 or 3, characterized in that the coating comprises phosphor-nickel and preferably phosphor-nickel with PTFE.

6. Wind instrument as claimed in any of the foregoing claims, characterized in that the tube comprises on its outer side at least one coating of phosphor-nickel, preferably phosphor-nickel with PTFE.

7. Wind instrument comprising a tube, holes of which are provided with valves pivotable on bearings, characterized in that at least one bearing surface, but preferably both mutually facing bearing surfaces of a bearing of a pivotable valve are provided with at least one coating reducing friction and/or wear, for instance of nickel applied without current and preferably a coating of nickel-phosphor with PTFE applied without current to this nickel coating.

8. Wind instrument as claimed in any of the foregoing claims, characterized in that in the case of a plurality of layers the coating has a thickness in total of a minimum of 7 μm and a maximum of 20 μm.

9. Wind instrument as claimed in any of the foregoing claims, characterized in that a number of valves (5) each comprise a stiff plate (26) which is provided on the side directed toward the opening (24) with a sealing layer (18) and which on the other side supports via a hard elastic cushion (92) against a support member (94) of control means (9) and is fixed to this support member (94) by means of a flexible fixing member (9).

10. Wind instrument as claimed in any of the foregoing claims, characterized in that a support member (94) mounted on a valve control arm (9) has a smaller diameter than the associated opening (24).
